(19) United States
(12) Patent Application Publication
(10) Pub. No.: US 2020/0031517 A1
(43) Pub. Date: Jan. 30, 2020

(54) RECYCLABLE LEAK RESISTANT CORRUGATED BOX

(71) Applicant: INTERSTATE RESOURCES, INC., Arlington, VA (US)

(72) Inventors: PETER A. BUGAS, Salisbury, MD (US); EDWARD J. FISH, Queenstown, MD (US)

(73) Assignee: INTERSTATE RESOURCES, INC., Arlington, VA (US)

(21) Appl. No.: 16/046,647

(22) Filed: Jul. 26, 2018

(51) Int. Cl. B65D 5/56; B65D 5/02; B65D 5/44; B65D 5/468; B65D 65/46; B31B 50/74

(52) U.S. Cl. CPC B65D 5/563; B65D 5/0254; B65D 5/445; B31B 50/73; B65D 65/466; B31B 50/747; B65D 5/4608

(57) ABSTRACT

A repulpable leak resistant poultry box having a composite corrugated structure with a fluted medium formed with a top backing board secured to one side of the fluted medium and a bottom backing board secured to the other side of the fluted medium, all of which are impregnated with a hydrogenated triglyceride and the backing boards are coated with an acrylic styrene copolymer. In one embodiment, the box has a bottom panel and end panels integral to bottom panel positioned at opposite ends of the bottom panel and separated by a fold line from the bottom panel. The side panels assemblies are integral with the bottom panel with each side panel being separated by a fold line and have a plurality of reinforcing end panels extending from opposite ends of the side panel and integral foldable cover members connected to the side panels by a fold line. The reinforcing end panels are connected to an adjacent end panel integral with the bottom panel by a corner tab formed by an angled cut adjacent each bottom corner of the end panel. A plurality of insert members are secured to opposing side panels, an end panel and the reinforcing end panels in the interior of the corrugated box.

Another box embodiment has a bottom panel, side panels assemblies integral with the bottom panel and end panels integral with the bottom panel. The side panel assemblies comprise a side panel and a plurality of reinforcing end panels positioned adjacent each side panel. Each of the reinforcing panels in the side panel assembly defines a U-shaped cut out which is aligned with a cut out in the end panel to present a single uniformly configured cut out. The end panels define a tab in each bottom corner connected to a reinforcing end panel to seal a bottom corner of the box.

### RELATED APPLICATIONS

There are no related applications.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The present invention generally relates to leak resistant and water proof paper products including linerboard and corrugated board that are environmentally friendly. Particularly, this invention relates to leak resistant corrugated paper boxes used primarily in the food industry for transporting poultry, meat, fish and produce which can be repulped and recycled after use to be part of the feedstock for other corrugated paper products.

### BACKGROUND OF THE INVENTION

In the manufacture of paper and paperboard and of products made from same, petroleum derived paraffin waxes and synthetic polymers have been used for many years as moisture retardants, water repellents, oil repellents, stiffeners, strengtheners, and release agents. Besides paraffin, a material often used in such paper products is polyethylene. However, other widely used polymers in the field include polymerized acrylics, vinyls, styrenes, ethylenes and copolymers or hetero-polymers of these monomers.

The paper and paperboard to which traditional wax materials are applied to control moisture is difficult and often impossible to repulp and recycle in standard paper mill processes because the petroleum derived polymers and, particularly, the petroleum waxes are non-biodegradable in mill white waters (circulated process waters) and discharge effluents. Furthermore, the residue of the petroleum waxes that are not removed from the pulp fibers during the repulping and recycling processes causes severe problems to the papermaking equipment due to buildup that occurs on the screens and felts used during the process of forming and making the paper or paperboard sheet. In addition, paper and paperboard coated or impregnated with petroleum waxes resist biodegradation and composting when disposed of in landfills and other waste disposal systems. Paper and paperboard coated or impregnated with traditional synthetic polymers and hetero-polymers are also difficult and often impossible to repulp and recycle owing to their resistance to separation from the fiber in the standard repulping processes resulting in significant fiber losses in efforts to repulp and recycle them. These products are non-biodegradable and therefore resist composting.

Water repellent packaging currently utilizes petroleum based liquid polymer coatings or polymer film laminates (including polyethylene or similar film laminates such as polyolefin, polyester, polyvinyl alcohol, polyvinyl acetate, polystyrene, polypropylene, and the like) which are recyclable after extensive treatment, All of these polymer coating and laminates require the installation of specialized repulping machinery that separates the pulp fibers from the coatings or laminated films and/or is far more expensive in terms of operating costs and/or recycled pulp fiber yields. Furthermore, the action of separating the fiber from the film damages some fibers causing the fibers to be selected out of the recycled pulp. The separated film waste carries some of the fibers out of the repulpate. In addition, coated and impregnated paper products incorporating paraffin waxes and/or similar petroleum derivatives can only be repulped for recycling in specially configured repulping equipment that removes and separates the paraffin waxes. In the laminated film repulping process, the more intense physical and chemical requirements of this repulping process coupled with the lost fibers that become trapped in paraffin wax wastes, causes the recyclable repulped fiber levels to fall far below those fiber levels required for standard repulping processes. Moreover, boxes made from such recycled repulped products are not biodegradable and must be separated and deposited in separate landfill areas.

The food box industry has previously used wax to coat the boxes (EVA—poly (ethylene vinyl acetate) used for shipping foodstuffs which takes a long period of time to compost and leaves a chemical residue from the coating compounds. There appears to be little or no decomposition of higher molecular weight resin and EVA fractions.

Many large end users such as Wal-Mart, Costco and the like are refusing to accept non-biodegradable and/or non-recyclable containers from suppliers. Also retail end users are subject to intense pressure from environmentally concerned customers or groups to use biodegradable containers. Furthermore, when food containers start to pool or collect fluid and spill or leak fluid on other containers, box crushing occurs and these crushed boxes may be returned with their contents to the seller of the goods or the receiver of the goods. Examples of end users which have such policies are KFC, US Foods, Sysco and Restaurant Depot. Alternatively, the end user themselves may be cited by health authorities. Thus, it can be seen that this is a significant problem when shipping or stacking fresh poultry, cut meats, seafood and fresh produce.

In the prior art, a number of patents have attempted to address the above noted problems but have only moved incrementally forward in solving the customer's problems. U.S. Pat. No. 6,103,308 issued Aug. 15, 2000 is directed toward a paper and paperboard coating composition using vegetable oil triglyceride as a paper coating while U.S. Pat. No. 6,201,053 issued Mar. 13, 2001 is directed toward various triglycerides mixed with catalysts for use as a waterproofing agent on paper coating.

U.S. Pat. No. 6,846,573 issued Jan. 25, 2005 discloses the use of hydrogenated triglycerides having a melting point above 50° as a coating material for the surface of paper products to improve wet strength and moisture resistance in addition to allowing the paper products to be repulpable.

U.S. Pat. No. 8,455,068 issued Jun. 4, 2013 discloses the combination of impregnation of the poultry boxes with hydrogenated triglyceride and covering the outer surface of the liners with a dimethyl or ethylene terephthalate (PET) resulting in corrugated poultry boxes which provided moisture resistance and were recyclable and repulpable.

U.S. Pat. No. 5,752,648 issued May 19, 1998 is directed toward an eight sided poultry box formed of corrugated paperboard. The lower ends of each of the four corner panels are provided with folds, which extend from the peripheral corner portions of the box bottom toward the exterior surfaces of the corner panels. The folds function as abutments and restrict rotational movement of the corner panels about their longitudinal axes occasioned by compressional forces generated on the box ends during shipment and handling. This box is widely used in the industry but allows corner leakage which causes corner crushing and panel tearing when the boxes are stacked.

U.S. Pat. No. 7,413,111 issued Aug. 10, 2008 is directed toward a container for storing and shipping produce which is reinforced with at least one cross beam extending across the bottom wall of the container to form a bridge under loose produce placed in the container to support at least a portion of the weight of the product and prevent sagging of the container bottom. The cross beam is positioned and held in place by engaging the ends of the cross beam in recesses formed by crushed areas on an inner surface of opposing side walls, or in cut outs in the side walls, and/or by flaps folded upwardly from the container bottom wall to which the cross beam is attached.

None of the noted references have provided a reliable, repulpable, recyclable corrugated box capable of holding fresh poultry, meats, seafood and produce and being leak resistant while maintaining crush and tear strength. All of these corrugated boxes are susceptible to corner leaks which spill out of the box chamber reducing box tear strength and increasing corner crushing. As an example, typically, poultry boxes are stacked seven layers high with seven boxes forming each layer. The prior art boxes allow collection of moisture and have leakage at the corners causing stacked boxes to crush and tear with spillage of the contents at the corners which results in boxes of poultry, meat, seafood, produce and other foodstuffs being rejected by the receiver of the goods and/or the end purchasers of the goods. The spillage also causes fluids to be discharged which can present a health hazard or contaminate foodstuffs in other containers.

The present invention has been developed to solve these problems in the industry.

### SUMMARY OF THE INVENTION

The present invention is directed to a repulpable recyclable leak resistant corrugated paper box which has the paper liner or backer sheet surfaces coated with a copolymer styrene acrylic emulsion with the backer sheets and inner corrugated paper fluted medium being impregnated with an animal or vegetable hydrogenated triglyceride. In one embodiment of the invention, the coated paper box is constructed with a bottom panel, side panel's assemblies which are integral to the bottom panel and end panels which are integral to the bottom panel. A plurality of insert members are glued to side panels and end panels of the box and together with corner tabs form leak resistant corners. Overlapping top panels are integral with the side panels and form the lid for the box.

In another embodiment of the leak resistant paper box without insert members, the side assembly panels have end reinforcement members which are glued to the end panels and have pre-cut corner sealing tabs.

It is an object of the invention to provide a leak resistant paper food container which is easier to repulp and recycle without detriment to repulping production equipment, processes, or manufactured product quality or performance.

It is further object of this invention to produce a leak resistant paper leak resistant cardboard food box product which can be compacted, repulped and recycled.

It is another object of the invention to produce a leak resistant paper food box which is biodegradable.

It is still another object of the invention to produce a leak resistant paper food box which has superior moisture resistance and does not leak at the corners.

It is yet another object of the invention to produce a leak resistant cardboard food box which has greater corner crush strength.

The invention will be better understood and objects other than those set forth above will become apparent when consideration is given to the following detailed description thereof. Such description makes reference to the annexed drawings wherein.

### BRIEF DESCRIPTION OF THE DRAWINGS

FIG. 1 is a perspective view of one embodiment of the inventive leak resistant food box with the lid covers closed;

FIG. 2 is a perspective view of the inventive leak resistant food box of FIG. 1 with the lid covers opened;

FIG. 3 is a perspective view of the inventive leak resistant food box of FIG. 1 standing on one end with the lid covers open with the interior of the food box disclosed;

FIG. 4 is an enlarged partial perspective end view of the inventive leak resistant food box of FIG. 1 showing inserts secured in the chamber of the leak resistant food box;

FIG. 5 is an enlarged partial perspective opposite end view from the inventive leak resistant food box of FIG. 4 showing an insert secured to the sides and rear end panel of the food box in the chamber of the leak resistant food box;

FIG. 6 is a top planar view of a blank for a single unit of the inventive leak resistant food box of FIGS. 1 and 2;

FIG. 7 is a top planar view of a multiple three unit blank for the blank of FIG. 6;

FIG. 8 is a top planar view of multiple insert blanks used in the inventive leak resistant food box of FIGS. 1-5;

FIG. 9 is a side perspective view of another embodiment of the inventive leak resistant food box;

FIG. 10 is an exploded perspective view of the inventive leak resistant food box of FIG. 9 with the box cover removed from the leak resistant box and placed adjacent the leak resistant box;

FIG. 11 is an enlarged end view of closed inventive leak resistant food box of FIG. 9;

FIG. 12 is a top plan view of a blank for the inventive leak resistant food box of FIG. 10 for a 19 inch length leak resistant box with 7 inch high side panels;

FIG. 13 is a top plan view of a blank for the inventive leak resistant box of FIG. 10 for a 19 inch length leak resistant box with 8 inch high side panels;

FIG. 14 is a top plan view of a blank for the inventive leak resistant box of FIG. 10 for a 19 inch length leak resistant box with 9½ inch high side panels;

FIG. 15 is a top plan view of a multiple box blank for the leak resistant box of FIG. 12;

FIG. 16 is a top plan view of a multiple box blank for the leak resistant box of FIG. 13; and

FIG. 17 is a top plan view of a multiple box blank for the leak resistant box of FIG. 14.

### DETAILED DESCRIPTION OF THE INVENTION

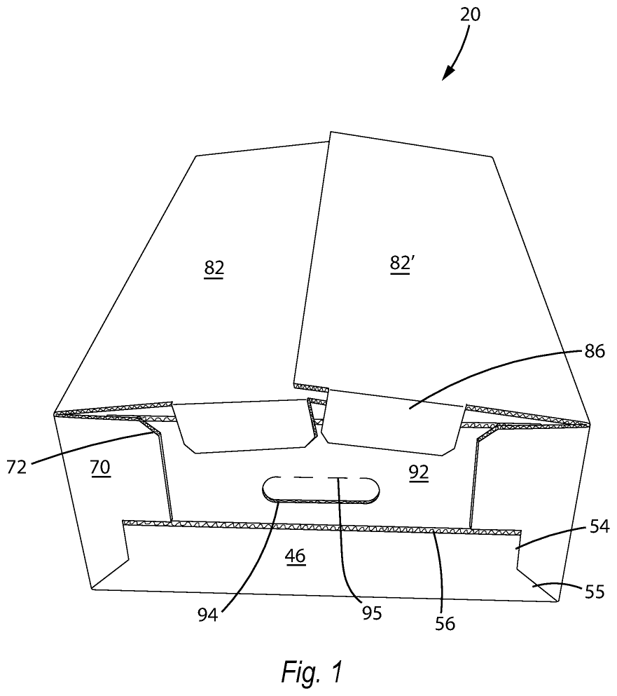

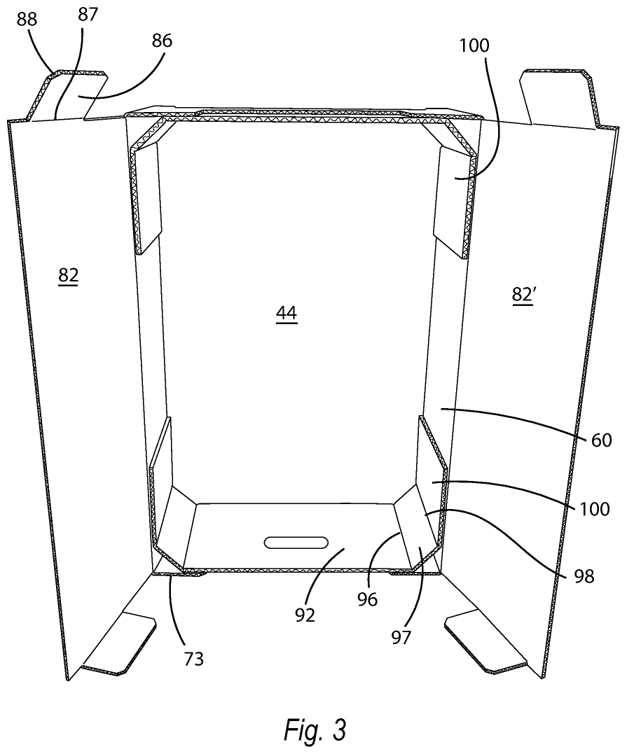

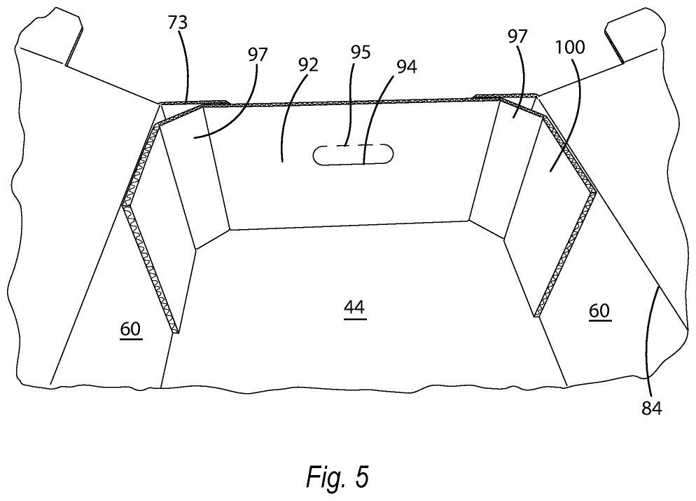

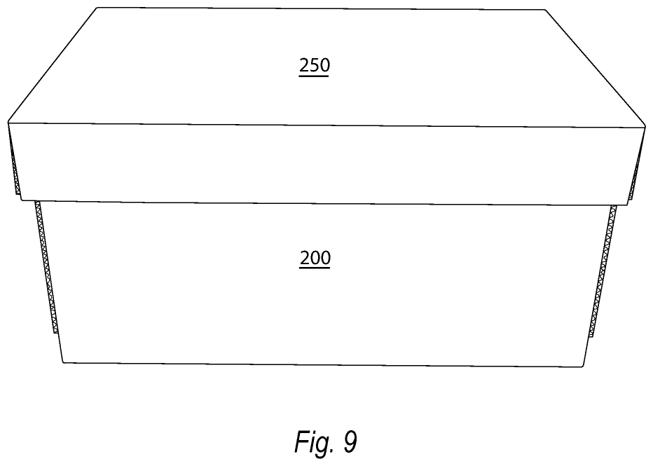

One preferred embodiment of the inventive leak resistant cardboard box invention is shown in FIGS. 1 through 8. An alternative preferred embodiment of the box is shown in FIGS. 9 through 17. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

### Definitions

As used herein the following abbreviations and terms are understood to have the meanings as set forth:

The term “Hydogenated Triglyceride” includes both animal fats and vegetable oils and is derived from one or more of them. Animal fats include beef tallow, pork lard, poultry grease and fish oils. Vegetable oils include palm oil, soybean oil, peanut oil, olive oil, coconut oil and cottonseed oil.

The term “Paraffin” is a wax-like product derived from petroleum.

The terms “Paper” and “Paperboard” includes substrates and surfaces of cellulosic material.

The term “Food Boxes” refers to corrugated cardboard boxes which are used to transport fluid carrying foods such as poultry, butchered meats, beef, pork, lamb, seafood and produce.

It has been found that hydrogenated triglycerides can be substituted for petroleum based paraffin waxes and wax compounds in the manufacture of paper products. All of these application systems involve melted hydrogenated triglycerides held at temperatures in the range from around 125° F. to 170° F. which is either squeezed, rolled, cascaded, sprayed, or doctored onto the linerboard, paper, carton stock, or corrugated medium surface to impregnate the same.

The method and machinery or equipment for repulping and recycling scrap paper in the paper and paperboard or liner board industry is both an established and well known art, and the equipment required is standard and commonly installed at most mills incorporating recycled paper in their manufacturing feed stocks. Thus, those skilled in the paper making art are also knowledgeable in re-pulping and recycling.

Food boxes are unique paper products that need to withstand water, poultry fluid, meat fluid, seafood fluid and produce fluid. The present inventive food box is made of double backed corrugated board having a corrugated medium of 30 to 40 lb./1000 sq. ft. (MSF) paperboard of an “A”, “B”, “C”, “E” and “F” flute size (weight depends upon various external factors).

A flat liner or backer board of Kraft paper (various grades) which has been impregnated with hydrogenated triglyceride and coated with a biodegradable water resistant plastic copolymer is glued to one side of an impregnated fluted medium with a starch based adhesive and a second flat liner or backer board of Kraft paper which has been impregnated with hydrogenated triglyceride and coated with a biodegradable water resistant plastic copolymer is adhered to the other side of the impregnated fluted medium with a starch based adhesive to form a backed corrugated board. The preferred flute size used in the Food Box invention is a “C” flute having 39+/−3 flutes per lineal foot with a flute thickness of 5/32 inch. The Kraft paperboard liner may be bleached white, coated white (white coat), mottled white or colored. As is well known in the art, the medium paper is humidified by means of high pressure steam which softens the paper fibers to facilitate the formation of the flute and consequent gluing. After formation of the board, this humidity is removed by drying in the dry-end. In the present invention, the newly formed corrugated liner board is heated from the bottom by hot plates and the adhesive holding components of the structure is cured.

The inventive present repulpable degradable leak resistant food box 20 as shown in FIG. 1 is constructed with an inner coated Kraft paper liner or backer glued to a corrugated paper medium and an outer coated Kraft paper liner or backer glued to the medium. Both of the liners and medium are impregnated with hydrogenated triglyceride and the liners are coated with a styrene acrylic co-polymer. Hydrogenated triglycerides which can be used in the invention are animal fats and vegetable oils. Animal fats include beef tallow, pork lard, poultry grease and fish oils. Vegetable oils include soybean oil, peanut oil, olive oil, palm oil, coconut oil and cottonseed oil with the preferred oil being palm oil. Hydrogenated triglycerides used in the impregnation are commercially available from C.J. Robinson Co. and Chemol Corporation.

Both liners or backers are coated on their outside surfaces with a coating of a styrene acrylic co-polymer water based solution ranging from about 75% to about 95% by weight. The coating emulsion is heated and mixed at the general time of application and heated to a temperature from about 160° F. to about 180° F., preferably at about 170° F.

The coating (not shown) is a styrene acrylic co-polymer solution (% by weight of the styrene acrylic co-polymer ranging from about 50% to about 55% most preferably about 52%) and has a pH ranging from about 8-9 with fully cured Tg of +7, a specific gravity ranging from about 1.04 to about 1.6 and viscosity (cps) of about 400. The coating has a vapor density the same as water with 30 minute Cobb values ranging from about 25 to about 35. The coating thickness is 3 lbs. per thousand square feet (MSF) and is fast drying, recyclable, repulpable, printable and glueable.

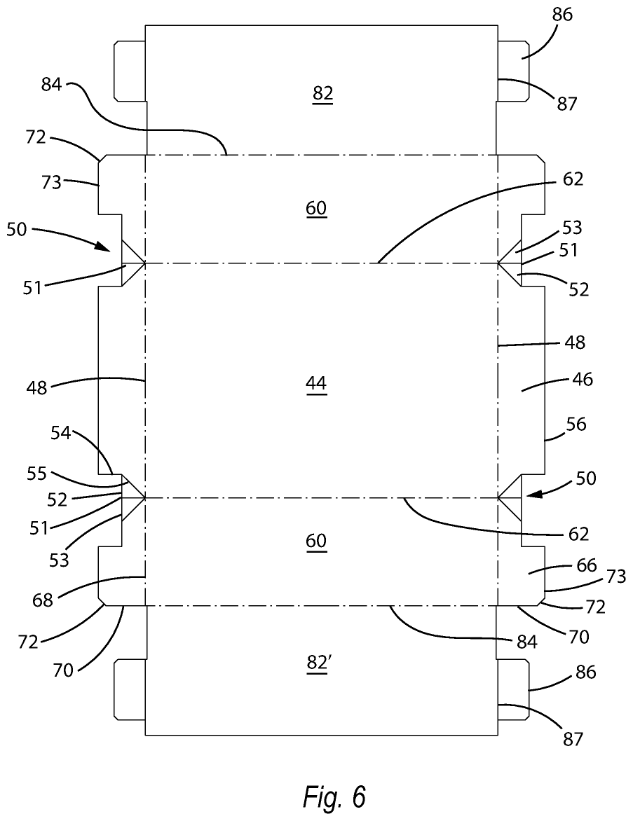

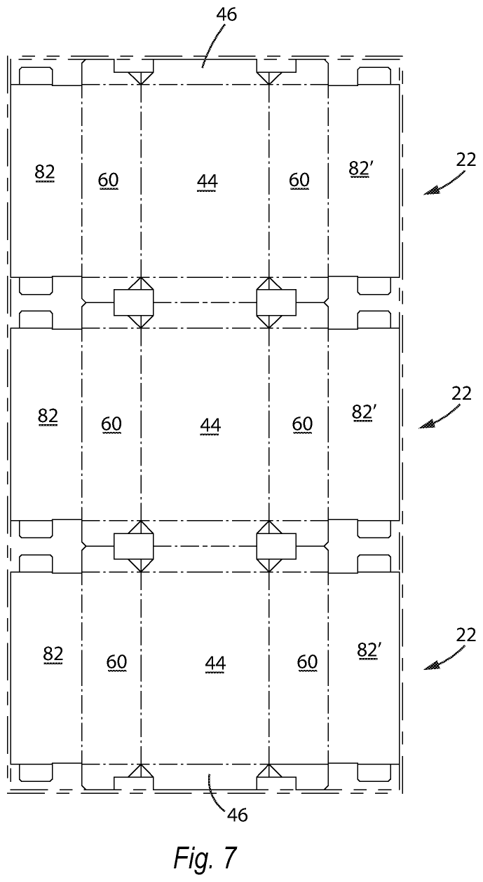

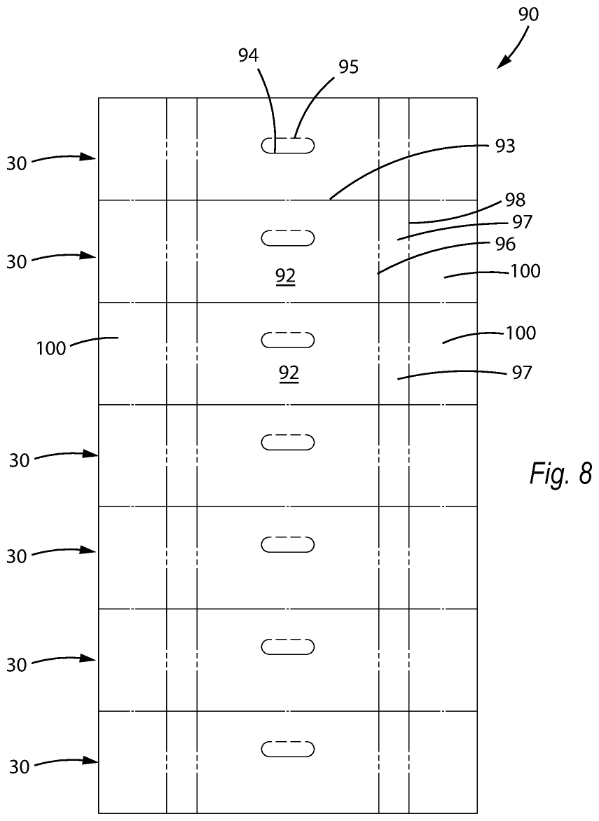

The inventive corrugated food box 20 is shown assembled in FIGS. 1-5 and is constructed from a cut and scored cardboard sheet blank 22 as individually shown in FIG. 6 and in blank multiples shown in FIG. 7. The food box insert members 30 are constructed from a single piece cardboard blank 90 as shown in FIG. 8.

The box blank 22 is a unitary double backed cardboard sheet manufactured as previously discussed which is cut and scored in a box cutting station to form a bottom or base panel member 44 with foldable end members 46 which are folded upward perpendicular from the bottom planar base 44 along fold lines 48. Each end member 46 is formed with foldable tab member 50 on each side which is scored at a 45° angle leading from the end member base section 55 at the intersection of fold lines 48 and 62 to the midpoint of the end member 46 at the beginning of the end member top section 54. The tab member 50 has a fold line 51 running down its middle which intersects the tab member into two identical sections 52 and 53. Tab section 53 is connected to side panel end tab 66 and its function will be described in the side panel description. The end member 46 has a top section 54 extending vertically upward from planar surface of the base member 44 and has a linear top end edge 56 which is parallel to the surface of the base member 44.

Side panels 60 are integrally connected to the bottom member or base 44 and folded perpendicular to the base planar surface along fold lines 62. Each side panel 60 has a foldable tab section 53 which is scored at a 45° angle from the intersection of fold lines 48 and 62 and is folded together with tab section 52 along tab mid-fold line 51 inward into the box chamber to engage the end opposite tab section 52. Tab section 52 and tab section 53 together form a 90° angle on the blank.

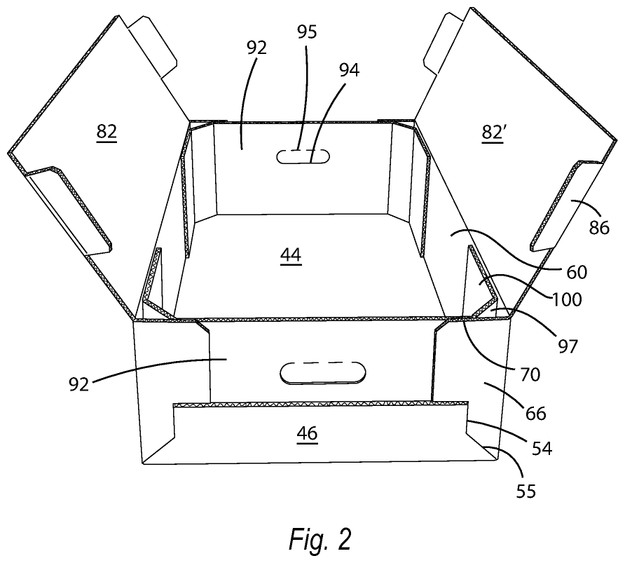

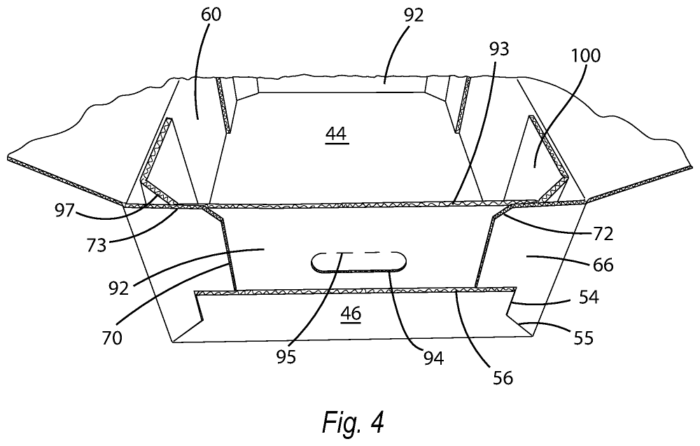

The folding of end tab 66 of the side panel along fold line 48 and the side panel side panel 60 along fold line 62 positions the end tab 66 adjacent the top section surface 54 and directly over the linear top end edge 56 of end member 46. The end tab 66 forward edge 70 extends from its position adjacent the linear top end edge 56 upward so that the end tab linear top edge 73 is aligned with the top edge 93 of the center panel 92 of insert member 30 when the insert member 30 is glued to the interior of the box as seen in FIGS. 2 and 4. The tab upper forward edge 70 is cut away and beveled 72 to form a 45° angle with a line drawn from the top edge 73.

The insert member 30 for the box is shown in FIGS. 2-5 and multiple insert member blanks are shown in the single piece rectangular blank 90 as shown in FIG. 8. The cardboard sheet for the blank 90 is constructed as previously discussed for the box sheets. The insert member 30 has a center panel 92 defining a central oval hand grip cut out 94 which is hinged 95 at its upper surface. The oval cut out 94 is preferably about 3 inches in length and 2 inches in height. Two parallel fold lines 96 and 98 intersect the top edge 93 and bottom edge of the insert member 30 rectangular blank to form a fold section 97 on each side of the central panel 92. The outer fold line 98 is integral with an adjacent outer end panel 100 on each end of the rectangular insert member blank. Each outer end panel 100 is glued to the inner surface of the side panels 60, with the fold section 97 being spaced over and not engaging the box corners. End tab 66 and end member 46 is glued to the center panel 92 as seen in FIGS. 2, 3 and 5. The insert member 30 is preferably 25 inches long and 6½ inches in height. The central section 92 of the insert member is 12 inches in width, the fold section 97 of the insert member is 2 inches in width and the outer end panels 100 of the insert member are each 4.08 inches in width.

The cover of the box 20 consists of overlapping rectangular panels 82 and 82′ each of which is integral to one of the side panels 60. The cover panels 82 and 82′ are folded inward along fold lines 84 to overlap and form the cover for box 20. Each cover panel 82 has a rectangular tab 86 extending outward from the end of the cover panel. The tabs 86 each define a rounded corner 88 as seen in FIGS. 2, 3, and 6. The tabs 86 are folded along fold line 87 so that the tabs can be inserted over box 20 and glued to the outside surface of the insert central panel 92 when the cover is closed. This enables the box 20 to remain closed once it is filled with product. One of the cover panels 82′ has a width ranging from 1¼ inches to 1¾, preferably 1½ inches which is greater than the width of the opposite cover panel 82 so that it overlaps the opposing cover panel as seen in FIG. 1.

The corrugated material forming the box 20 and insert members 30 are impregnated and coated in the same manner as previously described.

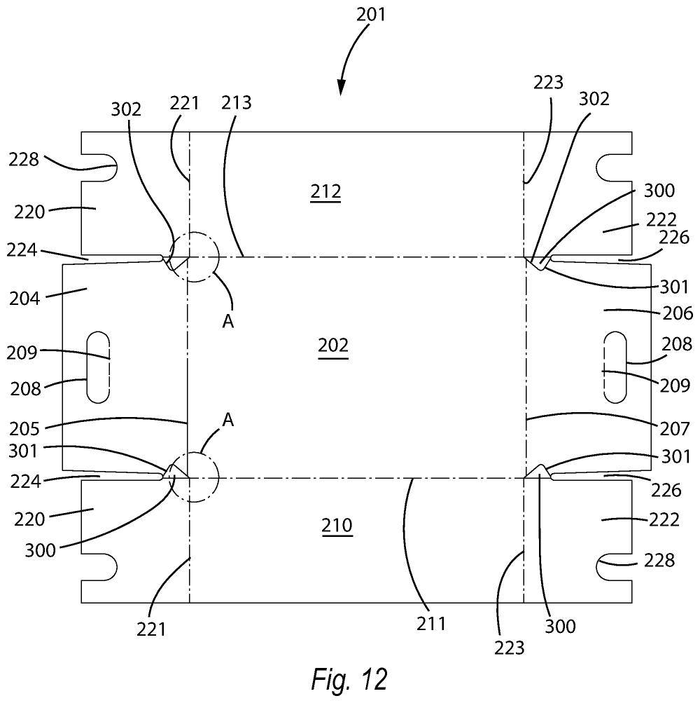

Another embodiment of the invention is an alternative leak resistant corrugated box 200 as shown in FIGS. 9-11 having a box blank 201 as shown in FIGS. 12-14. The box blank 201 is cut and scored in the box cutting station to form a bottom panel 202 with opposing integral end panels 204 and 206 each being joined to bottom panel 202 at the fold lines 205 and 207. Each of the end panels 204 and 206 has a partial hand cut out 208 with a lower hinge portion 209.

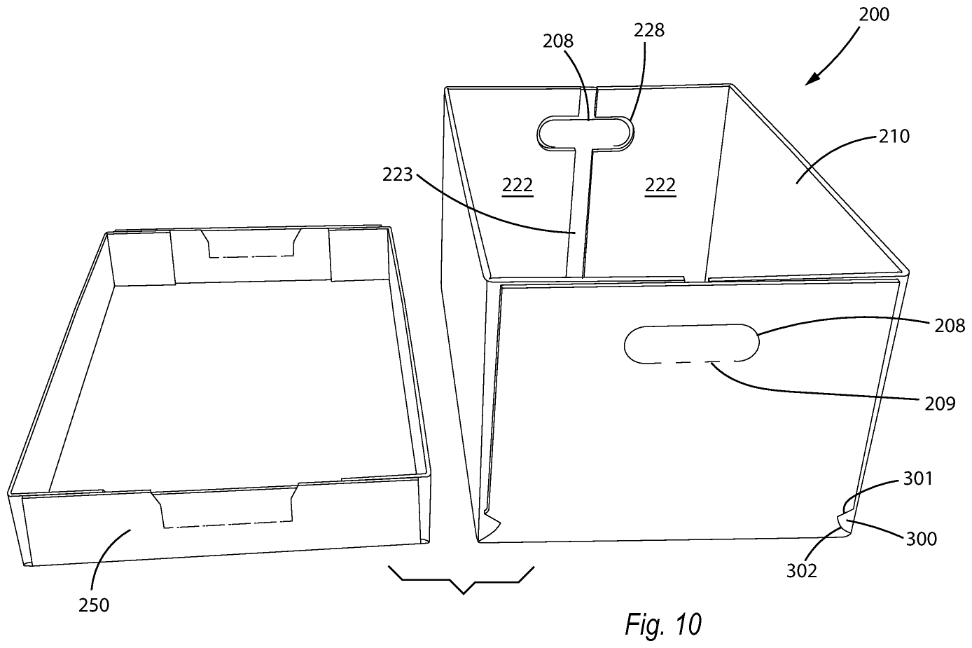

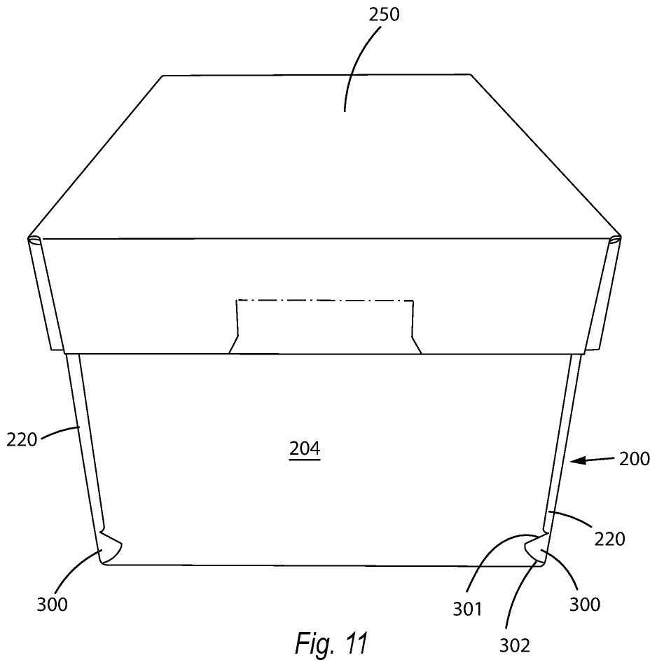

Side wall panels 210 and 212 are positioned on opposite sides of bottom panel 202 and are integral thereto being joined to the bottom panel 202 along their respective fold lines 211 and 213 allowing the side panels 210 and 212 to be folded upward and positioned transverse to the plane of the bottom or base panel 202. Each of the ends of the side panels 210 and 212 is integral with end reinforcing panels 220 and 222 and is joined to the end reinforcing panels by fold lines 221 and 223. The end reinforcing panels 220 and 222 are positioned on opposite ends of each of the side panels 210 and 212 and each end reinforcing panel defines a U-shaped cut out 228 in its distal end which fits adjacent to and around slightly less than ½ of the respective end panel cut out 208 leaving a gap 223 as shown in FIG. 10. Each of the end reinforcing panels 220, 222 are separated from the respective adjacent end panels 204 and 206 by parallel cuts 224, 226. These cuts allow the respective end reinforcing panels to be separated from the end panels 204 and 206 and folded to a transverse position so that U-shaped cut outs 228 of the reinforcing end panels are aligned with cut outs 208 of the end panels 204 and 206. Cut lines 224 and 226 are cut down the sides of end panels 204 and 206 respectively and reinforcing panels 220 and 222 but do not engage or intersect the fold lines 205 and 207 of the end panels or the fold lines 221 and 223 of the end reinforcing panels 220 and 222. It should be noted that fold lines 221 and 223 are offset from the fold lines 205 and 207 as shown in the area of dashed circle A, allowing corner tab 300 to be folded inward. The cut lines 224 and 226 end in the blank about 5/8 inch to about ¾ inch from the fold lines 205 and 221 and fold lines 207 and 223 as shown in FIGS. 10 and 12. When the adjacent reinforcing end panels are folded inward and the adjacent end panel is folded upward, they form an end panel assembly perpendicular to the bottom panel 202 as shown in FIG. 10. A corner seal tab 300 is formed by an upper angled cut 301 cut on angle about 45° from the end of cutline 224 or 226 in the end panel 204, 206 and a second distal score line 302 is made in the bottom corner of the respective end panel. Score line 302 if extended would intersect the upper angled cut 301. This tab area is also crushed by a die for easier folding. The cut 301 and score line 302 forms a generally triangular shaped seal tab 300 with its base adjacent and aligned with the either side panel fold lines 211 or 213 to form a pinched corner seal as best seen in the perspective views of FIGS. 10 and 11. As noted, the base of the triangular shaped tab 300 runs along the axis of line 211 or 213 and runs from the proximal end of cut 226 to the offset intersection of fold line 221 or 223 depending on the tab location of the corner of the box.

The pinched triangular shaped corner tab 300 ranges from ⅝ inch to about 1⅜ inch in length depending upon the length of angular cut 301 into the end panel and the corner seal depth desired when the box is assembled. The angular cut 301 is preferably at a 45° angle to fold line axis 211 or 213. The triangular shaped corner tab 300 preferably is crushed in the blank by the die as previously noted to allow easier folding. It should be noted that end reinforcing panel fold lines 221, 223 and the end panel fold line 205, 207 are offset 1/16 inch to 3/16 inch as shown in the FIGS. 12-14 so that the bottom panel 200 is slightly offset from the side panels 210 and 212 allowing the reinforcing panels 220 and 222 to be folded and positioned adjacent the end panels 204 and 206 and the crushed corner tabs 300 to be folded. The corner tabs 300 thus form a leak resistant seal for each corner of the box extending upward a predetermined distance preventing drainage of fluid at the corners which has leaked from the contained poultry, meat, seafood or produce into the box chamber.

The box 200 when folded has the reinforcement panels 220 and 222 folded inward and aligned to each other and parallel to the end panels 204 and 206. The end panels 204 and 206 are positioned on the outside of the box forming the exterior panel of the end panel assembly. All four reinforcing panels 220 and 222 are provided with a partial hand cut outs 228 which align with the hand cut outs 208 of end panels 204 and 206 when the box is assembled. As shown in FIG. 10, neither of the reinforcing panels free end edges engages the opposite end panel. The box 200 is provided with a standard lid or cover 250 which is well known in the art and is shown in FIGS. 10 and 11.

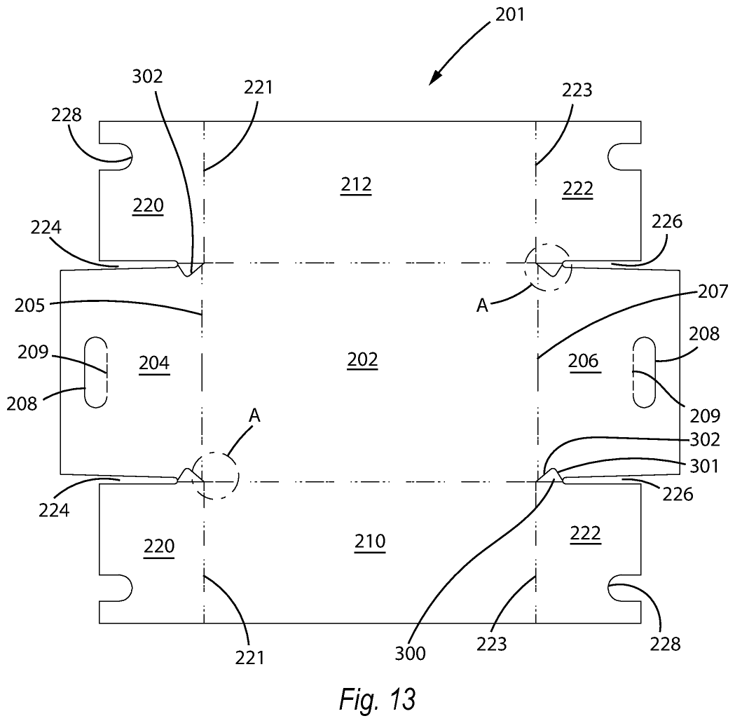

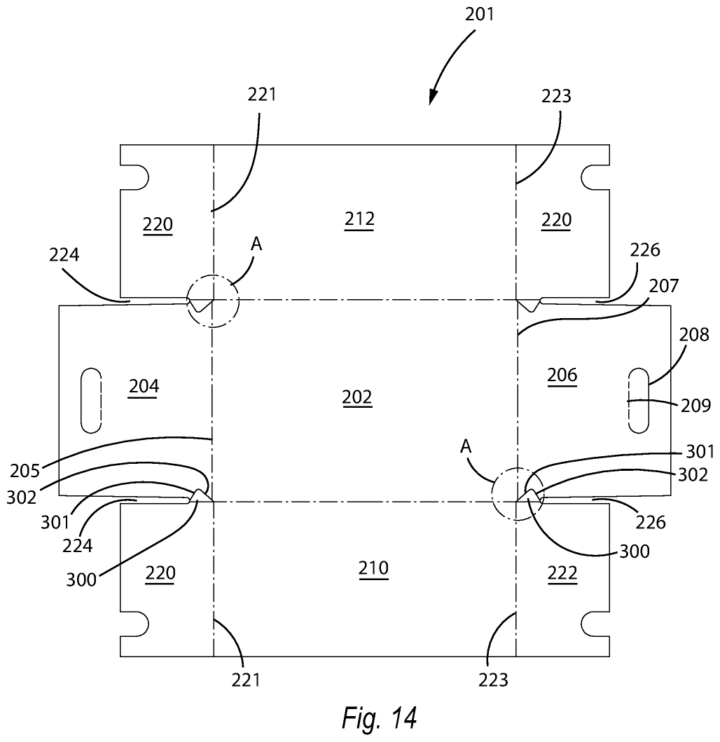

FIGS. 12-14 show different dimensioned box blanks according to the present invention in order of increasing depth. FIG. 12 is a box blank 33 inches in length and 26⅜ inches in width forming a box 19 inches by 12⅜ inches with a 7 inch depth. FIG. 13 is a box blank 35 inches in length and 28⅜ inches in width forming a box 19 inches by 12⅜ inches with an 8 inch depth. FIG. 14 is a box blank 38 inches in length and 31⅜ inches in width forming a box 19 inches by 12⅜ inches with a 9½ inch depth.

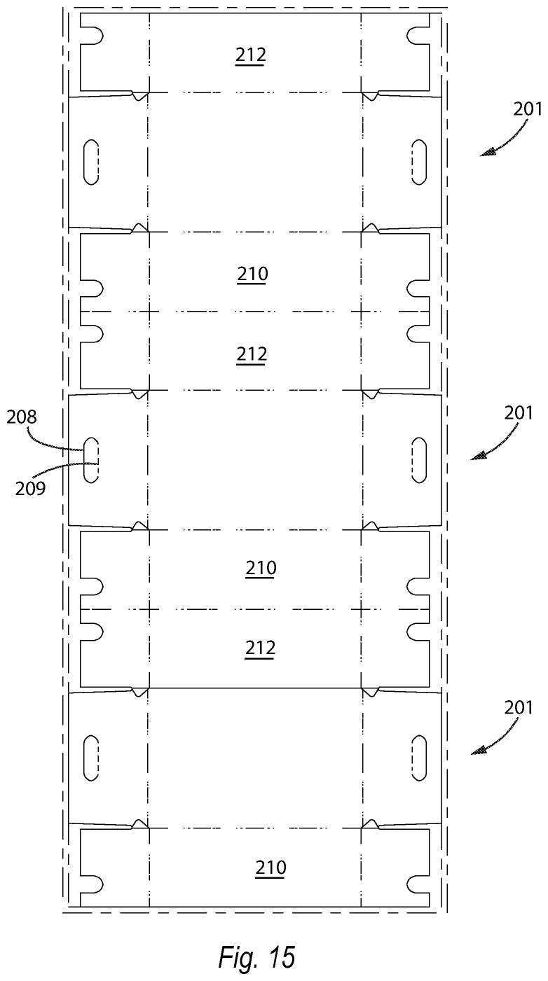

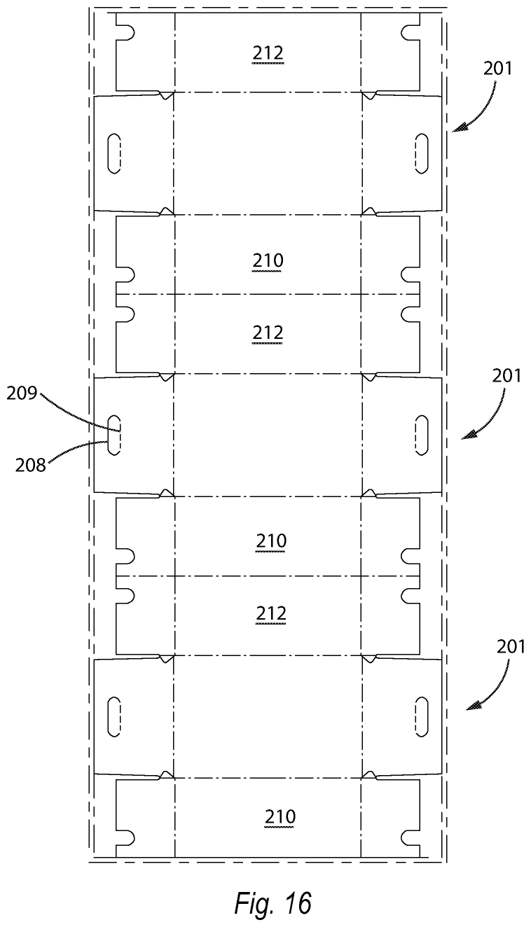

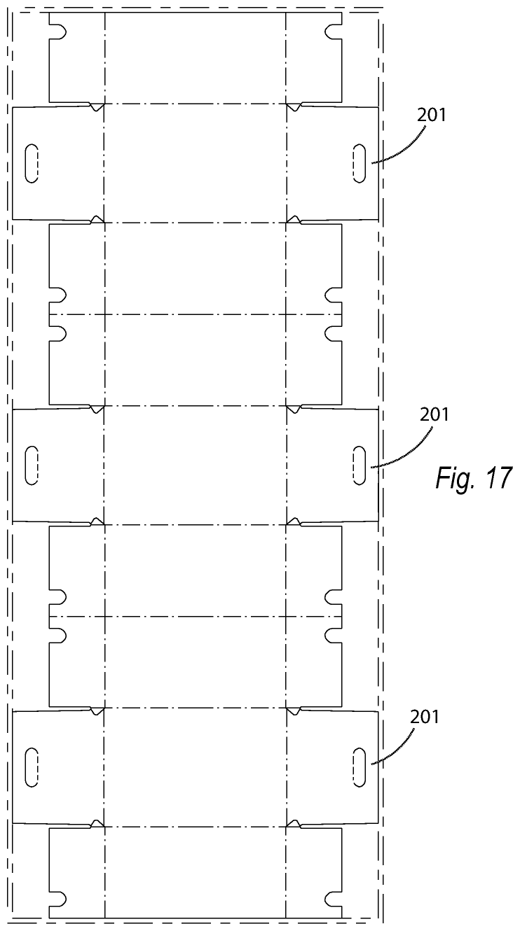

FIGS. 15-17 show multiple box blanks of this embodiment cut and scored in a single sheet of cardboard which correspond to the single box blanks in FIGS. 12-14. FIG. 12 shows single sheet of the box blank shown in FIG. 15, FIG. 13 shows a single box blank equating to the multiple blanks of FIG. 16 and FIG. 14 shows a single box blank equating to the multiple blanks of FIG. 17.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

1. A repulpable leak resistant corrugated box comprising a composite structure with a fluted medium, a top paper backing liner secured to one side of said fluted medium and a bottom paper backing liner secured to the other side of said fluted medium, with at least one of said paper backing liners and said fluted medium being impregnated with a hydrogenated triglyceride, and at least one of paper backing liners is coated with an emulsified copolymer mixture of styrene acrylic to provide moisture resistance and wet strength, said box comprising a bottom panel, multi sectioned end panels having one section integral to said bottom panel and adjacent end sections integral to a respective side panel assemblies, said side panels assemblies being integral with said bottom panel and being separated by a fold line from said bottom panel, each said side panel assembly comprising a side panel, a plurality of reinforcing end panels extending from opposite ends of said side panel and an integral foldable cover member connected to each said side panel by a fold line, said reinforcing end panels being connected to an adjacent end panel assembly integral with said bottom panel by a corner tab formed by an angled cut adjacent each bottom corner of said outer end panel, and a plurality of insert members secured to opposing side panels, each said insert member having a height which aligns with a height of said side panels, each insert member defines a center section which is secured to the end panel of said box, a corner section integral to each side of said center section which spans the corner of said box and a side section integral with each corner section separated by a fold line from said insert member corner section, said insert members being placed in and secured in the interior of said corrugated box.

2. (canceled)

3. The repulpable leak resistant corrugated box of claim 1 wherein said side panel assemblies include an integral foldable cover member connected to each said side panel by a fold line and foldable locking tabs extending from opposite ends of said cover member, said folding locking tabs being adapted to be fastened to an end panel by gluing same to an outside surface of said insert member.

4. (canceled)

5. (canceled)

6. The repulpable leak resistant corrugated box of claim 1 wherein the hydrogenated triglyceride is a hydrogenated vegetable oil selected from a group consisting of soybean oil, peanut oil, olive oil, palm oil, coconut oil and cottonseed oil.

7. The repulpable leak resistant corrugated box of claim 1 wherein the hydrogenated triglyceride is an animal fat selected from a group consisting of beef tallow, pork lard, poultry grease, and fish oils.

8. The repulpable leak resistant corrugated box of claim 2 wherein each insert member center section defines an oval cut out hinged at its top portion in said center section.

9. The repulpable leak resistant corrugated box of claim 1 wherein said corner tab has a triangular shape, with at least one angled cut line and a crushed corrugated body.

10. The repulpable leak resistant corrugated box of claim 1 wherein one foldable cover member has a greater width than the other cover member and overlaps said cover member.

11. (canceled)

12. The repulpable leak resistant corrugated box of claim 1 wherein said end reinforcement panel is offset from an end fold line defined by said bottom panel.

13. A repulpable leak resistant corrugated food box comprising a composite structure with a fluted medium, a top paper backing liner secured to one side of said fluted medium and a bottom paper backing liner secured to the other side of said fluted medium, said paper backing liners and said fluted medium being impregnated with a hydrogenated triglyceride and said paper backing liner then being coated with a biodegradable plastic copolymer styrene acrylic to provide moisture resistance and wet strength, said box comprising a bottom panel, side panels assemblies integral with said bottom panel and being separated by a fold line from said bottom panel, each said side panel assembly comprising a side panel, a plurality of reinforcing end panels sections extending from opposite ends of said side panel which fold to fit over said bottom panel end sections and a cover member foldably mounted to said side panel, each said reinforcing end panel being connected to an adjacent end panel assembly by a inwardly foldable corner tab formed by an angled cut adjacent each bottom corner of said outer end panel and a plurality of insert members mounted in said box, each of said insert members being secured to opposing side panels, an end panel and reinforcing panels connected to said side panel, each insert member being provided with a center section which is secured to an end panel, reinforcing panels on each side of said center section spanning an adjacent box corner, and an end section adjacent a distal side of said corner reinforcing panel, each end section being secured to a side panel of said box and foldable cover members separated from each said side panel by a fold line.

14. (canceled)

15. The repulpable leak resistant corrugated food box of claim 13 wherein one foldable cover member has a greater width than the other cover member and overlaps said cover member.

16. A repulpable leak resistant corrugated paper food box comprising a composite structure with a fluted medium, a top paper backing liner secured to one side of said fluted medium and a bottom paper backing liner secured to the other side of said fluted medium, said paper backing liners and said fluted medium being impregnated with a hydrogenated triglyceride, said paper backing liners have outer surfaces coated with an emulsified copolymer mixture of styrene acrylic, said box comprising a bottom panel, a plurality of end panels positioned on opposite sides of said bottom panel integral with said bottom panel separated by a fold line from said bottom panel, side panels assemblies integrally mounted to said bottom panel on opposite sides of said bottom panel, each side panel assembly being separated by a fold line from said bottom panel, each said side panel assembly comprising a side panel, a plurality of reinforcing end panels positioned on the ends of said side panel and a foldable cover member mounted to a distal side of said side panel, one of said foldable cover members having a greater width than the other cover member and overlaps said other corner member, said reinforcing end panels being integral with said side panel and a plurality of insert members mounted in said box and secured to opposing side panels, said reinforcing end panels being connected to said end panel by a corner tab, said corner tab being formed by an angled cut adjacent each bottom corner of said end panel, to form an adjacent flexible uncut section, said corner tab covering a bottom corner portion of said food box.

17. The repulpable leak resistant corrugated paper food box of claim 16 wherein a tab cut is made in each reinforcing panel of said end panel assembly angled towards said bottom panel at a distance ranging from about ¼ inch to about 1⅜ inches from said bottom panel.

18. A repulpable leak resistant corrugated box comprising a composite structure having a fluted medium, a top paper backing liner secured to one side of said fluted medium and a bottom paper backing liner secured to the other side of said fluted medium, with at least one of said paper backing liners and said fluted medium being impregnated with a hydrogenated triglyceride and at least one of said backing liners coated with a styrene acrylic co-polymer, said corrugated box comprising a bottom panel, end panels mounted on each end of said bottom panel and separated from said bottom panel by a fold line, side panels assemblies integral with said bottom panel and each said side panel assembly comprising an opposing side panel integral to said bottom panel and separated from said bottom panel by a fold line, and a plurality of reinforcing end panels mounted on each end of a side panel and adjacent to said end reinforcing panel, each end reinforcing panel being separated from said end panel by a cut line which does not extend to said bottom panel, each end reinforcing panel being integral to but separated from an associated side panel by a fold line, said fold line being offset from a reinforcing panel fold line, a corner tab integral with said end panel and an adjacent reinforcing end panel, a corner tab line beginning at the end of said cut line and angling into said end panel forming at least one side of said corner tab, said reinforcing end panels being connected to end panel by said corner tabs to seal the corners of said box, said end panel and adjacent reinforcing panels each forming a corner tab when the reinforcing panels are folded against the end panel, said corner tab having a substantially triangular shape with an angled cut line and a crushed corrugated body.

19. The repulpable leak resistant corrugated box of claim 18 wherein each reinforcing panel defines a U-shaped spaced cut out on a distal end and said outer end panel defines a partial cut out with a lower fold area.

20. (canceled)

21. A repulpable leak resistant corrugated box comprising a composite structure having a fluted medium, a top paper backing liner secured to one side of said fluted medium and a bottom paper backing liner secured to the other side of said fluted medium, said liners and fluted medium being impregnated with hydrogenated triglyceride, said paper backing liners and being coated with a styrene acrylic co-polymer, said box comprising a bottom panel, end panels integral to said bottom panel and separated by a fold line, side panel assemblies mounted to said bottom panel, each side panel assembly comprising a side panel and a plurality of reinforcing end
